(19) United States
(12) Patent Application Publication
(10) Pub. No.: US 2026/0244778 A1
(43) Pub. Date: Aug. 20, 2026

(54) Method and Apparatus for Managing Access to Vehicle Data Associated With a Motor Vehicle

(71) Applicant: Bayerische Motoren Werke Aktiengesellschaft, Muenchen (DE)

(72) Inventors: Matthias FINK, Muenchen (DE); Thomas NACHBAR, Poing (DE)

(21) Appl. No.: 19/542,785

(22) Filed: Feb. 18, 2026

(30) Foreign Application Priority Data
Feb. 19, 2025 (DE) 10 2025 106 202.1

(51) Int. Cl. G06F 21/62

(52) U.S. Cl. CPC G06F 21/6218

(57) ABSTRACT

An apparatus and method for managing access to vehicle data associated with a motor vehicle are provided. The method includes: detecting a release request of a user at a user terminal to provide access to vehicle data associated with a motor vehicle of the user, providing the release request to a remote vehicle computing device, receiving authentication identification information for the vehicle data from the remote vehicle computing device at the user terminal, providing the authentication identification information from the user terminal to a local service computing device, providing an access request from the local service computing device to the remote vehicle computing device to obtain access to the vehicle data, wherein the access request includes the authentication identification information, verifying the access request based on the authentication identification information, and providing the vehicle data to the local service computing device in response to the verification of the access request.

### CROSS REFERENCE TO RELATED APPLICATION

This application claims priority under 35 U.S.C. §119 from German Patent Application No. 10 2025 106 202.1, filed February 19, 2025, the entire disclosure of which is herein expressly incorporated by reference.

### BACKGROUND AND SUMMARY

The invention relates to a method and an apparatus for managing access to vehicle data associated with a motor vehicle.

Publication DE 10 2023 117 258 A1, for example, discloses a method for controlling a function of a vehicle, wherein a digital vehicle key is stored on a mobile terminal and a function of the vehicle can be controlled remotely by the digital vehicle key.

The object of the invention is to provide an improved method and an improved apparatus for managing access to vehicle data associated with a motor vehicle.

This object is achieved according to the invention by the subject matter of the independent patent claims. Advantageous embodiments of the invention are subject matter of the dependent patent claims and of the description.

A first embodiment of a method according to the invention for managing access to vehicle data associated with a motor vehicle comprises the steps of detecting a release request of a user at a user terminal in order to provide access to vehicle data associated with a motor vehicle of the user, providing the release request to a remote vehicle computing device, receiving authentication identification information for the vehicle data from the remote vehicle computing device at the user terminal, providing the authentication identification information from the user terminal to a local service computing device, providing an access request from the local service computing device to the remote vehicle computing device in order to obtain access to the vehicle data, wherein the access request includes the authentication identification information, verifying the access request on the basis of the authentication identification information, and providing the vehicle data from the remote vehicle computing device to the local service computing device in response to the verification of the access request.

In the further description there will be described a further, second embodiment, which achieves the same object mentioned at the beginning with similar means and for which the observations made for this first embodiment apply analogously.

Both the first and the second embodiment serve to provide vehicle data to a service provider or service company for a motor vehicle, such as, for example, a repair shop. In particular, the described embodiments serve to provide vehicle data to a service provider in a secure way that is protected from misuse. In particular, the described embodiments serve to authorize a service provider at a remote computing device so that the computing device provides him with the vehicle data. This is carried out according to the invention in particular with the aid of a user terminal which, however, does not itself contain or has not stored the desired vehicle data.

A user terminal, which can also be referred to as a user device, is a device or an apparatus that is configured to receive operator inputs, user inputs and/or user commands and to communicate with a motor vehicle in order in particular to provide these operator inputs to the motor vehicle and thus trigger functions at the motor vehicle.

In particular, the user terminal is a portable or mobile device that is different from the motor vehicle and can in particular be in the form of a so-called smart device, that is to say an apparatus having at least one processor device, such as, for example, a smart phone, a phablet or tablet, a smart watch, smart glasses and/or a wearable, which also provides other functions, such as, for example, making phone calls, surfing the internet or news services, for example, by means of applications or programs.

In particular, the user terminal is configured to trigger or carry out one or more functions in relation to one or more motor vehicles, such as, for example, locking and/or unlocking one or more hatches, such as, for example, doors, and in particular also actively opening and/or closing one or more such hatches, as well as releasing an immobilizer, starting an engine and/or moving the motor vehicle.

Such functions or interactions with the motor vehicle, in particular those which permit access to or hatch control and/or movement of the motor vehicle, can also be referred to as secure and/or secured functions and are supported in particular in or by the user terminal by a secure element, which may also be referred to as a secure module, or are implemented therein. Such a secure element can contain both hardware components, for example in the form of a secure processor and/or a secure memory region, and software components, for example, one or more apps, applications or programs, which work together.

In order to trigger such functions, the user terminal typically has at least one digital access key. Such a digital access key can in particular be based on an asymmetric cryptographic system and/or use such a system, wherein both the motor vehicle and the user terminal have a private key and a public key, which are configured to authorize or legitimize one another.

The first embodiment and the developments thereof will now be described first.

To this end, in a first step, a release request of a user is received at a user terminal in order to provide access to vehicle data associated with a motor vehicle of the user.

The release request serves to provide vehicle data to a third party, such as, for example, a service provider or a service company, such as a repair shop or a service point, or to a service computing device used by the service provider. A service provider is in particular a natural person who wishes to perform a service on the motor vehicle and in particular for this purpose wishes or has to access one or more pieces of vehicle data. The release request can also include or identify the service provider or the service company. Likewise, the release request can include one or more parameters which have been determined beforehand by the user, as will be described in the further description.

These vehicle data, which may also be referred to as vehicle information or motor vehicle information, include one or more pieces of data that describe and/or identify the motor vehicle, in particular a status, a diagnosis and/or a fault memory of the motor vehicle. These vehicle data are, however, in particular not stored on the user terminal but firstly in the motor vehicle, or are acquired there. These acquired vehicle data can then be transmitted once or at regular intervals, for no reason or in response to specific events, from the motor vehicle to a remote computing device, which may also be referred to as a vehicle computing device. When the term data or information is used in the following, it means both the singular and the plural, that is to say one piece of data or multiple pieces of information.

Such a remote computing device or vehicle computing device is different, separate and spaced apart from the motor vehicle and the user terminal. The remote vehicle computing device can comprise one or more servers, which can also be organized partially or entirely in the cloud. The remote vehicle computing device can in particular be operated by a manufacturer of the motor vehicle and can be used, in particular solely, for managing vehicle data for one or more motor vehicles.

Communication between the motor vehicle and the remote vehicle computing device and likewise between the user terminal and the remote vehicle computing device can take place in particular via one or more wireless communication protocols or standards, in particular far-field communication protocols, such as, for example, one or more of WLAN or WIFI, satellite communication, in particular Iridium, Orbcomm and/or Thuraya, and/or mobile communications, in particular 3G, 4G, 5G, etc. Communication can likewise take place between the remote vehicle computing device and a local service computing device, as will be described in the further description.

The previously received release request is then provided from the user terminal to the previously described remote vehicle computing device, as described above via a wireless communication protocol. It can be processed there and, in response thereto, authentication identification information for the vehicle data can be provided from the remote vehicle computing device to the user terminal, where it can be received. The authentication identification information is information that is used in the further course of the method to identify and/or authenticate the service provider or the local service company at the remote vehicle computing device, as will be described in the further description. The authentication identification information, which may also be referred to as authentication information or an authentication token, is in particular in the form of a unique character string, which in particular is generated and/or allocated by the remote computing device, in particular precisely for this purpose, and can include additional information, such as, for example, also one or more of the parameters previously transmitted from the user terminal, or pieces of information based on these parameters.

This authentication identification information is then provided from the user terminal 20 to a local service computing device. The local service computing device can in particular be in the form of a personal computer and can be connected to and/or comprise one or more servers. The service computing device is arranged at or in the service company and is used to carry out or at least assist with the service on the motor vehicle. In particular, the local service computing device also serves to process the vehicle data obtained in the further course of the method. The service computing device is referred to as local in particular because it is located locally at the site of the service that is to be provided and in particular also at a small distance from or in the vicinity of the motor vehicle and/or the user terminal, in contrast to the remote vehicle computing device, as will be explained in the further description.

An access request is then provided from the local service computing device to the remote vehicle computing device in order to obtain access to the vehicle data associated with the motor vehicle of the user. The access request includes the authentication identification information, or the authentication identification information is provided to the remote vehicle computing device for the purposes of authentication. This can likewise take place via a wireless communication protocol, as described above.

The access request is then verified at the remote vehicle computing device on the basis of the authentication identification information, for example, by comparison of the authentication identification information, and, if the verification has been successful, the vehicle data are provided from the remote vehicle computing device to the local service computing device.

The method according to the invention makes it possible for a service provider at a remote computing device to be authorized so that the remote computing device provides him with the vehicle data, which takes place with the aid of the user terminal which, however, does not itself contain or has not stored the desired vehicle data but authorizes particularly secure provision.

The method can be developed in that the authentication identification information includes vehicle identification information.

Vehicle identification information, which may also be referred to as vehicle information or a vehicle identification number, is a unique character string with which the motor vehicle is uniquely identifiable. The vehicle identification information can be identical to a chassis number, can include the chassis number or can be derived from the vehicle identification information.

In other words, the vehicle identification information is provided from the remote vehicle computing device to the user terminal, from there to the local service computing device and from there to the remote vehicle computing device. This vehicle identification information can in particular also be used at the remote vehicle computing device for verification purposes.

This development makes it possible for the vehicle data to be provided particularly securely.

According to a development, the method further comprises the step of verifying the authentication identification information at the local service computing device, wherein the provision of the access request takes place in response to the verification of the authentication identification information.

The authentication identification information is thus verified at the local service computing device, in particular by means of or on the basis of the vehicle identification information, for example by comparison with a database at the local service computing device, because the motor vehicle has already been stored therein.

Provision of the access request then takes place in particular only if this verification has been successful.

This development makes possible for the vehicle data to be provided particularly securely.

According to a development, the release request includes a scope of the vehicle data to be provided.

The release request received by the user at the user terminal can include one or more parameters, as described above, also including a scope of the vehicle data to be provided. A scope can include in particular a duration, a time, a type, a frequency and/or a quantity of the vehicle data to be provided. For example, the scope can define that the vehicle data may be provided from the remote vehicle computing device only today within the next two hours and may include only a fault memory but not, for example, an odometer reading.

This development makes it possible for the vehicle data to be provided particularly securely. In particular, misuse is thereby prevented particularly effectively.

According to a development, receiving of the authentication identification information incudes receiving a check request, wherein the method further comprises the steps of signing the check request with a digital key at the user terminal, providing the signed check request to the remote vehicle computing device, and verifying the signed check request at the remote vehicle computing device on the basis of the signature, wherein the provision of the authentication identification information takes place in response to the verification of the signed check request.

In other words, the authentication identification can include the check request or vice versa, or the authentication identification information can be provided together with the check request from the remote vehicle computing device to the user terminal. The check request can also include further information, in particular the vehicle identification information, the scope and/or a check identification, which may also be referred to as a nonce. The check request, which may also be referred to as a challenge, is a request to the user terminal to authenticate itself or to provide an authentication certificate.

To this end, the user terminal signs the check request with a digital key, in particular based on an asymmetric cryptographic system, and provides this signed check request back to the remote vehicle computing device, where this signed check request is then validated, for example with a key corresponding to the digital key. In response to a successful validation, a validation response can then be provided back to the user terminal. In particular only if the validation or validation response is positive, the authentication identification information is provided from the user terminal to the local service computing device.

This development makes it possible for the vehicle data to be provided particularly securely. In particular, misuse is thereby prevented particularly effectively.

According to a development, the digital key is a digital access key for the motor vehicle.

The digital key with which the check request is signed is in this development a valid digital access key for the motor vehicle. A key corresponding to this valid digital access key is stored at the remote vehicle computing device, whereby the digital key can be validated.

This development makes it possible for the vehicle data to be provided particularly securely. In particular, misuse is thereby prevented particularly effectively.

According to a development, signing of the check request takes place by a secure element of the user terminal.

According to this development, signing is carried out by a secure element of the user terminal.

This development makes it possible for the vehicle data to be provided particularly securely. In particular, misuse is thereby prevented particularly effectively.

According to a development, the method further comprises the steps of generating a machine-readable code including the authentication identification information at the user terminal and displaying the machine-readable code at the user terminal, wherein the provision of the authentication identification information takes place by reading of the machine-readable code by the local service computing device.

A machine-readable code is a code that can be detected and evaluated by an optical sensor, such as a camera. The machine-readable code is in particular a barcode and/or a quick response code, a so-called QR code. This is generated at the user terminal and displayed there, for example on a display. The local service computing device is able to read this code, for example because it has a camera or has access thereto, wherein the code itself includes at least the authentication identification information and is thus provided to the local service computing device.

This development makes it possible for the authentication identification information to be transmitted particularly quickly and easily and in particular without the need for a special chip for near-field communication.

According to a development, provision of the authentication identification information takes place via near-field mobile communication.

This can take place both alternatively and in addition to the use of a machine-readable code. Near-field mobile communication is a wireless communication technology which functions only at small distances between the transmitter and the receiver, for example, less than 50m, 25m, 15m, 10m or 5m. Such near-field mobile communication is, for example, NFC, RFIC, Bluetooth and/or UWB. This takes place, for example, by moving the user terminal closer to the local service computing device or vice versa, so that data including the authentication identification information can then be exchanged or provided from the user terminal to the local service computing device.

This development makes it possible for the authentication identification information to be transmitted particularly quickly and easily.

The object mentioned at the beginning is also achieved by a second embodiment of a method for managing access to vehicle data associated with a motor vehicle.

This embodiment comprises the steps of detecting a release request of the service provider at the local service computing device in order to obtain access to vehicle data associated with the motor vehicle of the user, providing the release request to the remote vehicle computing device from the service computing device, receiving authentication identification information for the vehicle data from the remote vehicle computing device at the local service computing device in response to the release request, providing the authentication identification information to the user terminal, signing the authentication identification information at the user terminal, providing the signed authentication identification information from the user terminal to the local service computing device, providing an access request from the local service computing device to the remote vehicle computing device in order to obtain access to the vehicle data associated with the motor vehicle of the user, wherein the access request includes the signed authentication identification information, verifying the access request on the basis of the signed authentication identification information, and providing the vehicle data from the remote vehicle computing device to the local service computing device in response to the verification of the access request.

For this embodiment, the observations made above in relation to the first embodiment substantially apply, and in particular also the developments thereof.

According to a further aspect, an apparatus for managing access to vehicle data associated with a motor vehicle is provided.

The apparatus comprises means for carrying out one or more embodiments of the method described above. In particular, the apparatus comprises one or more processor devices for carrying out the method described above. Also in particular, the apparatus comprises a memory on which there is stored, in particular in a non-volatile manner, code which, when executed by a processor device, causes the processor device to carry out the method described above.

In particular, the apparatus can comprise a user terminal, one or more remote or local computing devices, in particular a remote vehicle computing device and/or a local service computing device, or can form a system therewith in order to carry out or at least to effect the method described above. The apparatus can also comprise one or more motor vehicles and/or a fleet of motor vehicles comprising multiple motor vehicles, or can form a system therewith. In particular, the apparatus can comprise any device as described above or can form a system therewith.

Further features of the invention will become apparent from the claims, the figures and the description of the figures. The features and feature combinations mentioned above in the description as well as the features and feature combinations mentioned below in the description of the figures and/or shown in the figures alone are usable not only in the combination mentioned in each case but also in other combinations or on their own.

The invention will now be explained in greater detail by means of a preferred exemplary embodiment and with reference to the drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic perspective view of an embodiment of a method and of an apparatus for managing access to vehicle data associated with a motor vehicle;

FIG. 2 shows a schematic flow diagram of an embodiment of a method for managing access to vehicle data associated with a motor vehicle; and

FIG. 3 shows a schematic flow diagram of an embodiment of a method for managing access to vehicle data associated with a motor vehicle.

### DETAILED DESCRIPTION OF THE DRAWINGS

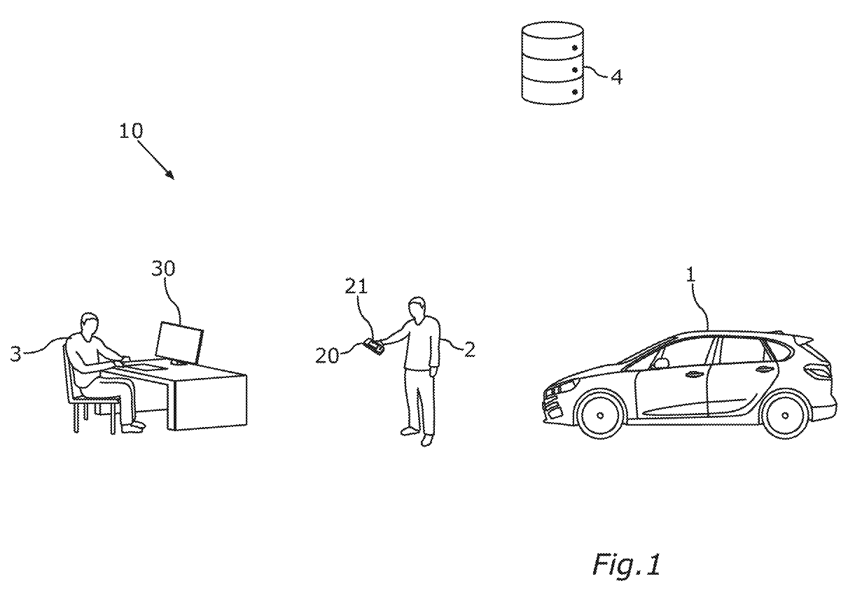

FIG. 1 shows a schematic perspective view of an embodiment of a method and of an apparatus 10 for managing access to vehicle data associated with a motor vehicle 1.

The apparatus comprises the user terminal 20 of a user 2, a remote vehicle computing device 4 and a local service computing device 30 of a service provider 3. The apparatus 10 is configured to carry out or at least to effect the method steps described in the following.

The apparatus 10 is configured to detect a release request of the user 2 at the user terminal 20 in order to provide access to vehicle data associated with the motor vehicle 1 of the user 2. The release request includes a scope of the vehicle data to be provided.

The apparatus 10 is also configured to provide the release request to the remote vehicle computing device 4.

The apparatus 10 is also configured to receive authentication identification information for the vehicle data from the remote vehicle computing device 4 at the user terminal 20. The authentication identification information includes vehicle identification information. Receiving the authentication identification information also comprises receiving a check request from the remote vehicle computing device 4.

The apparatus 10 is also configured to sign the check request with a digital key at the user terminal 20. The digital key is a digital access key for the motor vehicle 1. Signing of the check request takes place by a secure element of the user terminal 20.

The apparatus 10 is also configured to provide the signed check request to the remote vehicle computing device 4.

The apparatus 10 is also configured to verify the signed check request at the remote vehicle computing device 4 on the basis of the signature.

The apparatus 10 is also configured to provide the authentication identification information from the user terminal 20 to the local service computing device 30 in response to the verification of the signature.

The apparatus 10 is in particular configured to generate a machine-readable code including the authentication identification information at the user terminal and to display the machine-readable code at the user terminal 20.

Provision of the authentication identification information takes place in particular by reading of the machine-readable code by the local service computing device 30.

Alternatively or in addition, the apparatus 10 is configured to provide the authentication identification information via near-field mobile communication.

The apparatus 10 is also configured to verify the authentication identification information at the local service computing device 30, in particular on the basis of the vehicle identification information.

The apparatus 10 is also configured, in response to the verification of the authentication identification information at the local service computing device 30, to provide an access request from the local service computing device 30 to the remote vehicle computing device 4 in order to obtain access to the vehicle data, wherein the access request includes the authentication identification information.

The apparatus 10 is also configured to verify the access request at the remote vehicle computing device 4 on the basis of the authentication identification information.

The apparatus 10 is also configured to provide the vehicle data from the remote vehicle computing device 4 to the local service computing device 30 in response to the verification of the access request.

Alternatively or in addition, the apparatus is configured to carry out or at least to effect the method described in the further description.

The apparatus 10 is configured to receive a release request from the service provider 3 at the local service computing device 30 in order to obtain access to vehicle data associated with the motor vehicle 1 of the user 2.

The apparatus 10 is also configured to provide the release request to the remote vehicle computing device 4.

The apparatus 10 is also configured to receive authentication identification information for the vehicle data from the remote vehicle computing device 4 at the local service computing device 30.

The apparatus 10 is also configured to provide the authentication identification information to the user terminal 20.

The apparatus 10 is also configured to sign the authentication identification information at the user terminal.

The apparatus 10 is also configured to provide the signed authentication identification information from the user terminal 20 to the local service computing device 30.

The apparatus 10 is also configured to provide an access request from the local service computing device 30 to the remote vehicle computing device 4 in order to obtain access to the vehicle data, wherein the access request includes the signed authentication identification information.

The apparatus 10 is also configured the verify the access request at the remote vehicle computing device 4 on the basis of the signed authentication identification information.

The apparatus 10 is also configured to provide the vehicle data from the remote vehicle computing device 4 to the local service computing device 30 in response to the verification of the access request.

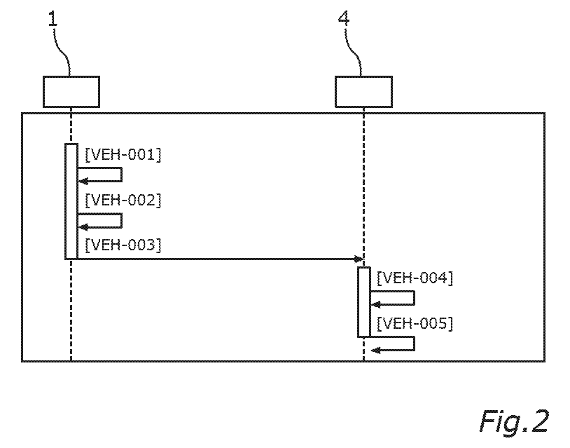

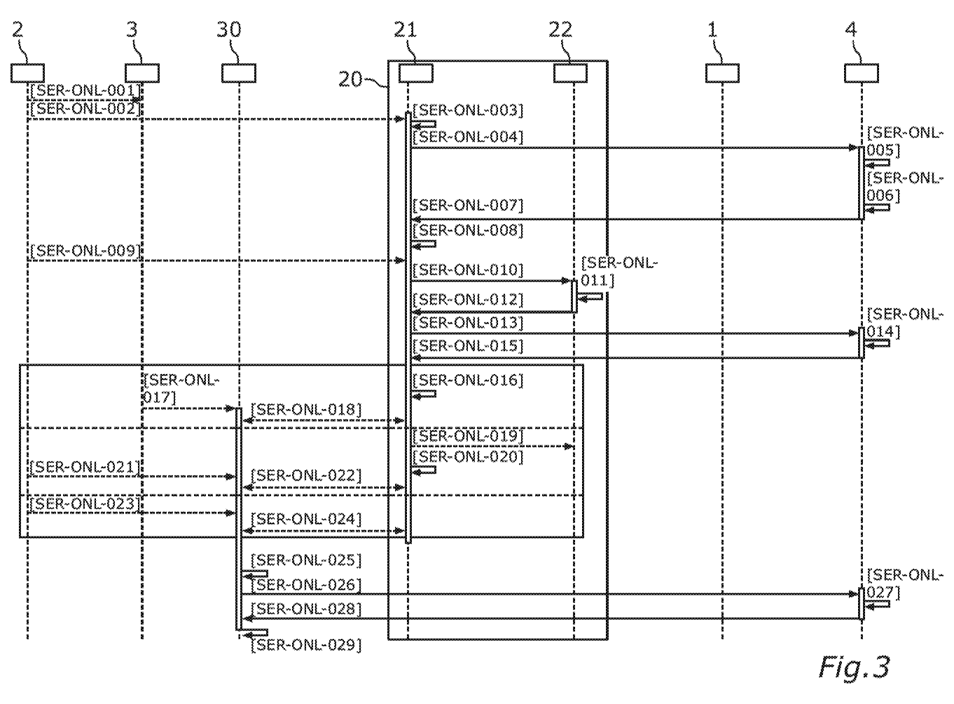

Detailed method steps as described in connection with this FIG. 1 will now be explained with reference to the following FIG. 2 and 3. There is described in particular the interaction of the user 2 with a service provider 3, the local service computing device 30 thereof, the user terminal 20 of the user 2, the motor vehicle 1 of the user 2 and a remote vehicle computing device 4. The user terminal 20 comprises at least one application 21, in particular an application 21 that is responsible or adapted inter alia or solely for managing access to vehicle data of the motor vehicle 1 and therefore may also be referred to as a management application, and also an operating system 22 on which the at least one application 21 is operated.

FIG. 2 shows a schematic flow diagram of an embodiment of a method for managing access to vehicle data associated with a motor vehicle. FIG. 2 first shows the synchronization of vehicle data, access to which is to be managed or permitted, between the motor vehicle 1 and the remote vehicle computing device 4.

In a first method step VEH-001 of this method stage, the vehicle data are acquired at the motor vehicle 1 and collated. These vehicle data can include, for example, diagnostic data, status data, configuration data and/or user data.

In a further method step VEH-002, these vehicle data are encrypted at or by the motor vehicle 1 and, in a further method step VEH-003, these encrypted vehicle data are transmitted or provided from the motor vehicle 1 to the vehicle computing device 4.

In a further method step VEH-004, the provided and encrypted vehicle data are received at the vehicle computing device 4 and verified and, in a further method step VEH-005, are stored permanently or in a non-volatile manner at the vehicle computing device 4.

This method stage shown here in this FIG. 2 takes place in particular at regular intervals, periodically and/or continuously, or is carried out repeatedly. In particular, this method stage takes place in response to a specific event, in particular because a specific action has been carried out at the motor vehicle 1 and/or at the user terminal, and/or for no reason or unprompted.

FIG. 3 shows a schematic flow diagram of a further embodiment of a method for managing access to vehicle data associated with a motor vehicle.

In particular, the method stage shown in connection with this FIG. 3 follows the method stage from FIG. 2 or has been passed through at least once before the method stage from FIG. 2 is carried out.

In a first method step SER-ONL-001 of this method stage, a registration request of the user 2 for a service in relation to the motor vehicle 1 is provided to the service provider 3. The service concerns, for example, a planned or unplanned repair shop appointment, for example for an inspection or a tire change of the motor vehicle 1. This service request is made in particular in person, for example, by the user 2 visiting the service provider in person by attending a service company, such as a repair shop.

In a further method step SER-ONL-002, a release request of the user 2 is received in the application 21 at the user terminal 20 relating to the service registered in the previous step in order to provide access to vehicle data associated with the motor vehicle 1 of the user 2. This release request may also be referred to as a check-in request and/or booking-in request and serves to release vehicle data that are relevant for the service and are not stored at the user terminal 20 for the service provider 3 or the local service computing device 30.

In a further method step SER-ONL-003, one or more parameters for the service of the release request are selected or set by the user 2. These can include, for example, a scope of the vehicle data to be released.

In a further method step SER-ONL-004, the release request together with the scope is sent or provided to the remote computing device 4.

In a further method step SER-ONL-005, authentication identification information is prepared at the remote vehicle computing device 4 and, in a further method step SER-ONL-006, further information, such as check identification information, vehicle identification information and the scope defined by the user 2, are added together with the authentication identification information to a check request, or the check request is prepared therefrom.

In a further method step SER-ONL-007, the check request is provided to the user terminal 20, where it is processed.

In a further method step SER-ONL-008, information from the check request is provided or displayed to the user 2 at the user terminal 20 for release and, in a further method step SER-ONL-009, this release is granted by the user 2. This release can be processed further either immediately or at a later time.

In a further method step SER-ONL-010, the operating system 22 and in particular a secure element comprised or controlled thereby is requested by the application 21 to sign the check request with a digital access key for the motor vehicle 1, which is stored in or managed by the secure element.

In a further method step SER-ONL-011, this check request is then signed by the secure element and provided to the application 21 in a further method step SER-ONL-012.

In a further method step SER-ONL-013, this signed check request is then provided to the remote vehicle computing unit, where it is verified or validated in a further method step SER-ONL-014.

If the verification has been successful, it is provided in a further method step SER-ONL-015 to the user terminal 20 in a verification response.

In the following, three different possibilities for providing the authentication information from the user terminal 20 to the local service computing device 30 will be described, these possibilities not being mutually exclusive and being applicable both one after the other and simultaneously.

Steps SER-ONL-016, 017 and 018 describe a first form in which the authentication information is provided via a machine-readable code, steps SER-ONL-019, 020, 021 and 022 describe a further form in which the authentication information is provided via near-field mobile communication, such as, for example, NFC, and steps SER-ONL-023 and 024 describe yet a further form in which the authentication information is provided via a different communication protocol, for example, UWB.

In a method step SER-ONL-016, the machine-readable code is generated on the basis of the authentication information and is displayed at the user terminal 20.

In a further method step SER-ONL-017, this machine-readable code is detected by the local service computing device 30 and, in a further method step SER-ONL-018, this code is read and thus the authentication information is provided to the local service computing device 30.

Alternatively or in addition, in a method step SER-ONL-019, the user terminal 20 is prepared for NFC communication and, in a further method step SER-ONL-020, the user is requested to move the user terminal into the vicinity of the local service computing device 30, which the user 2 does in a further method step SER-ONL-021.

In a further method step SER-ONL-022, the authentication information is provided to the local service computing device 30 via NFC.

Alternatively or in addition, in a method step SER-ONL-023, provision or retrieval of the authentication information is requested by a user input of the user 2 with the aid of a further communication protocol, and this is effected in a further method step SER-ONL-024.

Regardless of how the authentication information has been provided from the user terminal 20 to the local service computing device 30, the method continues with step SER-ONL-025, in which the authentication information is verified at the local service computing device, in particular also on the basis of the vehicle identification information, which is included in the authentication information, for example, by comparison with a database.

If this verification has been successful, an access request is provided in a further method step SER-ONL-026 from the local service computing device 30 to the remote vehicle computing device 4 in order to obtain access to the vehicle data, wherein the access request includes the authentication identification information.

In a further method step SER-ONL-027, the validity of the previously received access request is checked or validated at the remote vehicle computing device 4 and, if the result of this validation is positive, the requested vehicle data are provided from the remote vehicle computing device 4 to the service computing device 30 in a further method step SER-ONL-028.

Then, in a further, final step SER-ONL-029, the vehicle data are displayed there or provided to the service provider 3 for further use.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of reference signs

1 motor vehicle

2 user

3 service provider

4 remote vehicle computing device

10 apparatus

20 user terminal

21 application

22 operating system

30 local service computing device

VEH-001 method step

VEH-002 method step

VEH-003 method step

VEH-004 method step

VEH-005 method step

SER-ONL-001 method step

SER-ONL-002 method step

SER-ONL-003 method step

SER-ONL-004 method step

SER-ONL-005 method step

SER-ONL-006 method step

SER-ONL-007 method step

SER-ONL-008 method step

SER-ONL-009 method step

SER-ONL-010 method step

SER-ONL-011 method step

SER-ONL-012 method step

SER-ONL-013 method step

SER-ONL-014 method step

SER-ONL-015 method step

SER-ONL-016 method step

SER-ONL-017 method step

SER-ONL-018 method step

SER-ONL-019 method step

SER-ONL-020 method step

SER-ONL-021 method step

SER-ONL-022 method step

SER-ONL-023 method step

SER-ONL-024 method step

SER-ONL-025 method step

SER-ONL-026 method step

SER-ONL-027 method step

SER-ONL-028 method step

SER-ONL-029 method step

What is claimed is:

1. A method for managing access to vehicle data associated with a motor vehicle, the method comprising:
detecting a release request of a user at a user terminal to provide access to vehicle data associated with the motor vehicle of the user;
providing the release request to a remote vehicle computing device;
receiving authentication identification information for the vehicle data from the remote vehicle computing device at the user terminal;
providing the authentication identification information from the user terminal to a local service computing device;
providing an access request from the local service computing device to the remote vehicle computing device in order to obtain access to the vehicle data, wherein the access request includes the authentication identification information;
verifying the access request based on the authentication identification information; and
providing the vehicle data from the remote vehicle computing device to the local service computing device in response to the verification of the access request.

2. The method according to claim 1, wherein the authentication identification information includes vehicle identification information.

3. The method according to claim 2, further comprising:
verifying the authentication identification information at the local service computing device;
wherein provision of the access request takes place in response to the verification of the authentication identification information.

4. The method according to claim 1, wherein the release request includes a scope of the vehicle data to be provided.

5. The method according to claim 2, wherein the release request includes a scope of the vehicle data to be provided.

6. The method according to claim 3, wherein the release request includes a scope of the vehicle data to be provided.

7. The method according to claim 1, wherein receiving the authentication identification information comprises receiving a check request;
wherein the method further comprises:
signing the check request with a digital key at the user terminal;
providing the signed check request to the remote vehicle computing device; and
verifying the signed check request at the remote vehicle computing device based on the signature; and
wherein provision of the authentication identification information takes place in response to the verification of the signed check request.

8. The method according to claim 2, wherein receiving the authentication identification information comprises receiving a check request;
wherein the method further comprises:
signing the check request with a digital key at the user terminal;
providing the signed check request to the remote vehicle computing device; and
verifying the signed check request at the remote vehicle computing device based on the signature; and
wherein provision of the authentication identification information takes place in response to the verification of the signed check request.

9. The method according to claim 3, wherein receiving the authentication identification information comprises receiving a check request;
wherein the method further comprises:
signing the check request with a digital key at the user terminal;
providing the signed check request to the remote vehicle computing device; and
verifying the signed check request at the remote vehicle computing device based on the signature; and
wherein provision of the authentication identification information takes place in response to the verification of the signed check request.

10. The method according to claim 7, wherein the digital key is a digital access key for the motor vehicle.

11. The method according to claim 7, wherein the signing of the check request is executed by a secure element of the user terminal.

12. The method according to claim 10, wherein the signing of the check request is executed by a secure element of the user terminal.

13. The method according to claim 1, further comprising:
generating a machine-readable code including the authentication identification information at the user terminal; and
displaying the machine-readable code at the user terminal;
wherein provision of the authentication identification information takes place by reading of the machine-readable code by the local service computing device.

14. The method according to claim 2, further comprising:
generating a machine-readable code including the authentication identification information at the user terminal; and
displaying the machine-readable code at the user terminal;
wherein provision of the authentication identification information takes place by reading of the machine-readable code by the local service computing device.

15. The method according to claim 3, further comprising:
generating a machine-readable code including the authentication identification information at the user terminal; and
displaying the machine-readable code at the user terminal;
wherein provision of the authentication identification information takes place by reading of the machine-readable code by the local service computing device.

16. The method according to claim 1, wherein provision of the authentication identification information takes place via near-field mobile communication.

17. The method according to claim 2, wherein provision of the authentication identification information takes place via near-field mobile communication.

18. The method according to claim 3, wherein provision of the authentication identification information takes place via near-field mobile communication.

19. A method for managing access to vehicle data associated with a motor vehicle, the method comprising:
detecting a release request of a service provider at a local service computing device to obtain access to vehicle data associated with the motor vehicle of a user;
providing the release request to a remote vehicle computing device;
receiving authentication identification information for the vehicle data from the remote vehicle computing device at the local service computing device;
providing the authentication identification information to the user terminal;
signing the authentication identification information at the user terminal;
providing the signed authentication identification information from the user terminal to the local service computing device;
providing an access request from the local service computing device to the remote vehicle computing device to obtain access to the vehicle data, wherein the access request includes the signed authentication identification information;
verifying the access request based on the signed authentication identification information; and
providing the vehicle data from the remote vehicle computing device to the local service computing device in response to the verification of the access request.

20. An apparatus for managing access to vehicle data associated with a motor vehicle, wherein the apparatus is configured to execute a method according to claim 1.
